(19) United States
(12) Patent Application Publication
(10) Pub. No.: US 2014/0314963 A1
(43) Pub. Date: Oct. 23, 2014

(54) PLANT AND METHOD FOR IMMERSION OF BODYWORKS

(71) Applicant: Giampaolo Covizzi, Cinisello Balsamo (IT)

(72) Inventor: Giampaolo Covizzi, Cinisello Balsamo (IT)

(73) Assignee: GEICO S.P.A., Cinisello Balsamo (IT)

(21) Appl. No.: 14/358,328

(22) PCT Filed: Nov. 12, 2012
(86) PCT No.: PCT/IB2012/056349

§ 371 Date: May 15, 2014

(30) Foreign Application Priority Data
Nov. 17, 2011 (IT) MI2011A002090

(51) Int. Cl. B65G 49/04; B05D 1/18; B05C 3/10

(52) U.S. Cl. CPC B65G 49/0413; B05C 3/10; B05D 1/18
USPC 427/430.1; 118/423

(57) ABSTRACT

A plant for dipping treatment of bodyworks may include, the plant comprising: at least one processing liquid basin; a conveying line for sequential arrival of skids toward a front end of the basin and sequential departure of the skids from a rear end of the basin, the skids each configured to support a bodywork; first and second roller units above the basin, the first roller unit at the front end of the basin and the second roller unit at the rear end of the basin; and two immersion and conveying assemblies, each provided with a movable platform for supporting and engaging the skids, for removing a respective one of the skids from the first roller unit, conveying the respective one of the skids immersed along the basin, and depositing the respective one of the skids onto the second roller unit.

The present invention relates to a plant for the immersion processing of bodies, in particular of motor vehicles and the like.

In the art processes for the dipping treatment of bodyworks, intended to perform, for example, cataphoresis and anti-corrosive pre-treatment, are known.

The end quality of the dipping treatment depends to a large extent on the mode of immersion of the part to be treated. For example, to ensure uniformity of the treatment it is extremely important to avoid the presence of air bubbles which may remain trapped during immersion. In fact, the trapped bubbles would prevent suitable contact of the treatment liquid with the immersed bodywork. Moreover, it is important that no zones with an excessive amount of stagnating liquid should remain when the bodywork is removed from the liquid, in order to prevent both unnecessary dripping along the line and non-uniform and excessive coating. The difficulty of achieving satisfactory results becomes even greater in the zones of box-shaped parts which are more difficult to access.

Moreover, the mode and speed of immersion and emersion are of importance also in order to minimize the mechanical stresses which are induced on the bodywork by the hydrodynamic resistance and which may result in unacceptable deformation as well as excessive stressing of the moving structure.

On the other hand, it is also important that the plant should perform treatment as fast as possible in order to optimize the processing time and increase productivity with a reduction in the volumes.

An example of a known station envisages the use of travelways along which suitable conveying units, called “skids”, are moved, these skids each carrying a bodywork to undergo treatment. The conveying line is continuous and along the path varies in height so as to be immersed in one or more treatment baths. In this way the bodyworks, following the path of the conveying line, enter into and out of the basins along the path. This system has, among other things, the drawback that it requires relatively long basins in order to allow entry and exit of the conveying system and also a suitable dipping time of the bodywork being conveyed. In addition to the size, the length of the basins is also a problem owing to the high volume of processing liquid which must be used, with consequent high costs for the acquisition and subsequent disposal thereof Moreover, with a variation in the vehicle bodies to be treated, there is no possibility of optimizing the immersion and emersion movements in order to ensure removal of the air, avoid the presence of bubbles and optimize the stresses.

WO 03/070545 describes a horizontal conveying line which has zones for downwards rotation of the vehicle bodies opposite treatment basins. Each skid is relatively complex since it has its own system for overturning the bodywork being conveyed.

DE4410477 describes a system which has a small basin with an overturning device to which the vehicle bodies are fed in sequence. The system is of the “stop and go” type in the sense that the bodywork must remain overturned inside the basin for the entire duration of the treatment. This system is therefore able to achieve only a low production output and is not very flexible, allowing only rotation of the bodywork about a fixed axis.

WO2009/083081 and WO2009/103400 propose the use of a complex overhead conveyor with a plurality of carriages which have raising arms which hang downwards and terminate in a support element which is rotatable about a horizontal axis and to which the bodywork is attached. The overhead conveyor travels along a line and passes above one or more processing basins. When a carriage is located vertically above the basin it lowers the support element with the bodywork so as to immerse the body inside the basin, while it inclines or rotates it by means of the motor-driven support. The horizontal movement of the carriage may continue with the bodywork immersed until it emerges at the opposite end of the basin. This system also has a continuous conveyor with a single conveying device and the flexibility of the system is relatively limited.

DE102010001366 describes a plant similar to the preceding one, but with the carriage which also has a ground rail which is common to all the conveyors in the plant.

Other systems which envisage a system separate from the conveyor for overturning the vehicle bodies inside the basins do not solve the problem of rapid loading and unloading of the bodies onto/from the overturning system and/or do not ensure a suitable flexibility of the immersion movements in order to avoid bubbles or stagnation.

EP 2192989 proposes using a platform supported at the corners by four columns each provided with an independent elevator such that the platform moves only vertically and may be inclined by means of an independent control system for the four elevators. A horizontal conveying system loads and unloads the platform which, owing to the separate control of the four elevators, may immerse the bodywork vertically with various inclinations which can be varied depending on the body being treated. The processing basin may thus be small, it being sufficient for it to accommodate the bodywork, and removal of the air and stagnation of the liquid may be controlled in an optimum manner The cost, overall volume and efficiency are significantly improved compared to the previous solution and several basins may also be arranged in series, each with their own vertically moving platform. This solution, however, is not optimum for the immersion of all types of bodywork and nevertheless occupies a certain volume owing to the four independent elevators.

The general object of the present invention is to provide a dipping treatment plant and movement method which, while occupying a relatively small volume and having a relatively low cost, are able to ensure a high degree of flexibility and quality of treatment also with a large range of different bodyworks.

In view of this object, the idea which has occurred according to the invention is that of providing a plant for the dipping treatment of bodyworks, comprising at least one processing liquid basin, a conveying line for the sequential arrival of skids towards a front end of the basin and the sequential departure of skids from the opposite rear end of the basin, the skids being intended to each support a bodywork to be treated; a first and a second roller unit arranged above the basin, the first roller unit being arranged at said front end of the basin and the second roller unit being arranged at said rear end of the basin, in order to receive or release a skid from and towards the conveying line, the rollers of the first and second roller units being movable between a non-operating retracted position and an operating position for slidably displacing and supporting a skid above the basin at the corresponding end of the basin; two immersion and conveying assemblies each provided with a movable platform for supporting and engaging with a skid for removing a skid from the first roller unit, conveying it immersed along the basin and depositing it onto the second roller unit, the platform being supported by a transverse motor-driven rotating shaft which projects from a support arm which is motor-driven for the vertical movement of the platform and which is in turn moved by motor-driven system for alternating displacement thereof along the basin between the first and second roller units.

Another idea which has occurred is that of providing a sequential movement method for the dipping treatment of a plurality of bodyworks, comprising the following steps of providing:
at least one processing basin;
a conveying line for the sequential arrival of skids towards a front end of the basin and the sequential departure of skids from the opposite rear end of the basin, the skids being intended to each support a bodywork to be treated;
a first and a second roller unit arranged above the basin, the first roller unit being arranged at said front end of the basin and the second roller unit being arranged at said rear end of the basin, in order to receive or release a skid from and towards the conveying line, the rollers of the first and second roller units being movable between a non-operating retracted position and an operating position for slidably displacing and supporting a skid above the basin at the corresponding end of the basin;
two immersion and conveying assemblies each provided with a movable platform for supporting and engaging with a skid for removing a skid from the first roller unit, conveying it immersed along the basin and depositing it onto the second roller unit, the platform being supported with a transverse motor-driven rotating shaft which projects from a support arm which is motor-driven for the vertical movement of the platform and which is in turn moved by a motor-driven system for alternating displacement thereof along the basin between the first and second roller units; and

performing sequentially, by means of one of the two immersion and conveying assemblies, a movement for immersion and conveying, immersed, between a first and a second roller unit a bodywork arriving on the first roller unit and returning it onto the second roller unit, while the other of the two immersion and conveying assemblies performs an opposite return movement above the basin between the first roller unit and second roller unit for removal of the next bodywork arriving at the first roller unit.

In order to illustrate more clearly the innovative principles of the present invention and its advantages compared to the prior art, an example of embodiment applying these principles will be described below, with the aid of the accompanying drawings. In the drawings:

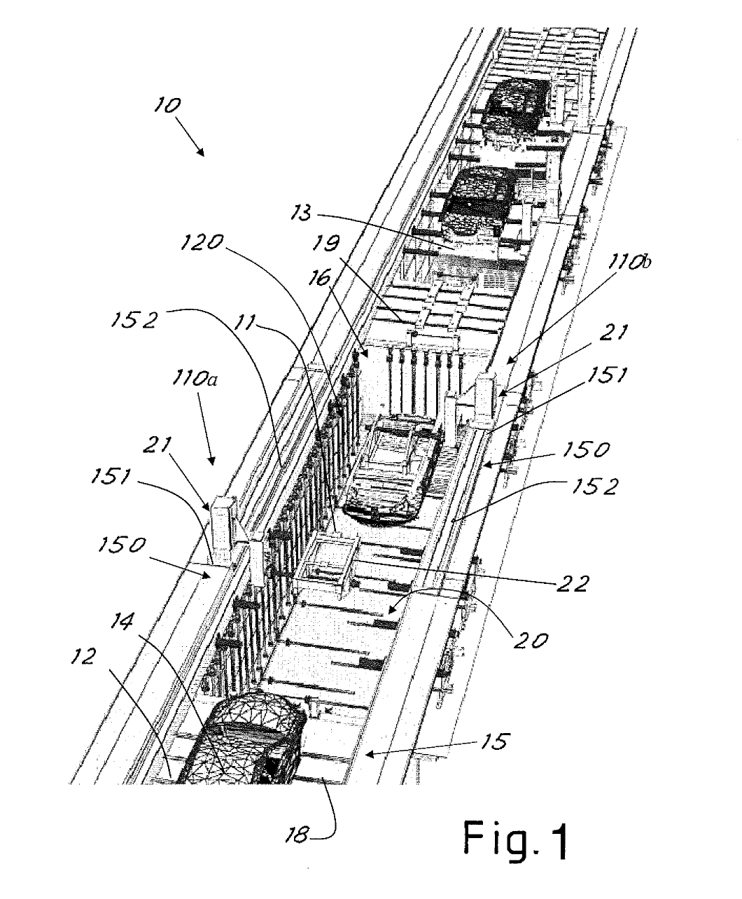

FIG. 1 shows a schematic perspective view of a plant according to the invention;

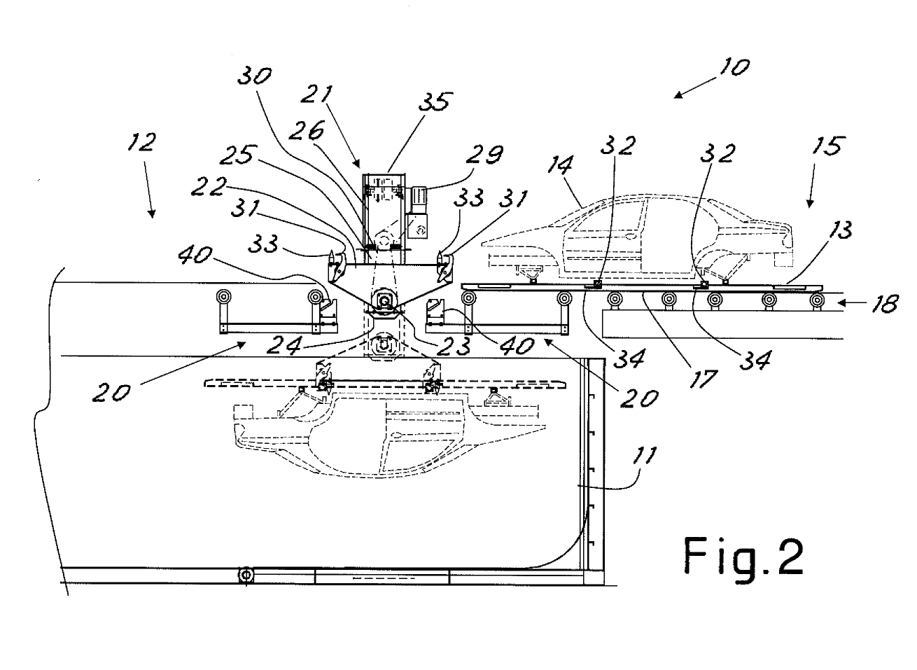

FIG. 2 shows a schematic partially sectioned side view of an entry zone of the plant according to FIG. 1;

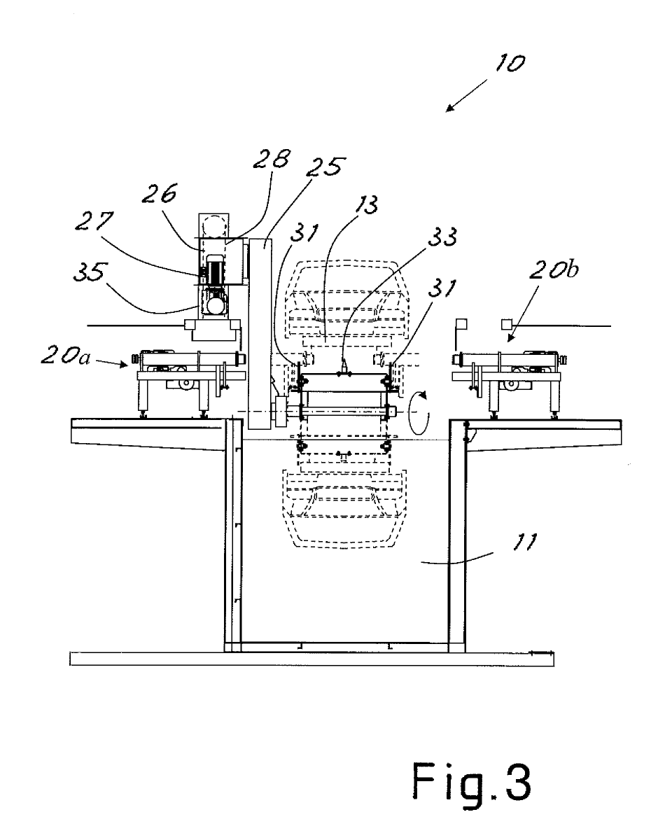

FIG. 3 shows a schematic view of the zone shown in FIG. 2, viewed along a cross-section;

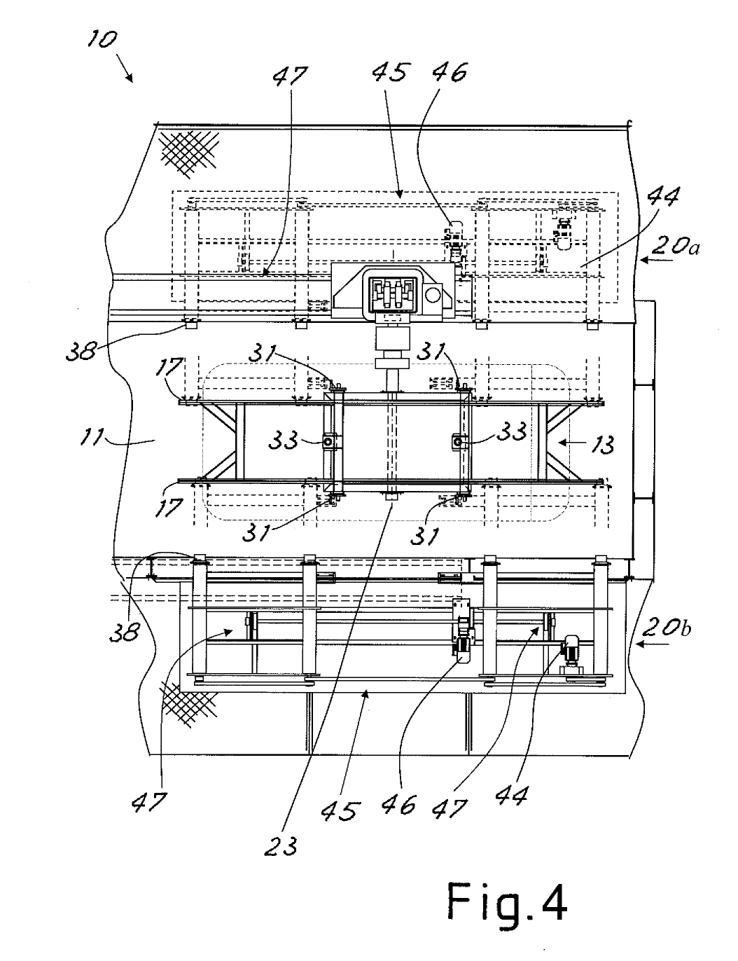

FIG. 4 shows a schematic partially sectioned plan view of the zone according to FIG. 2;

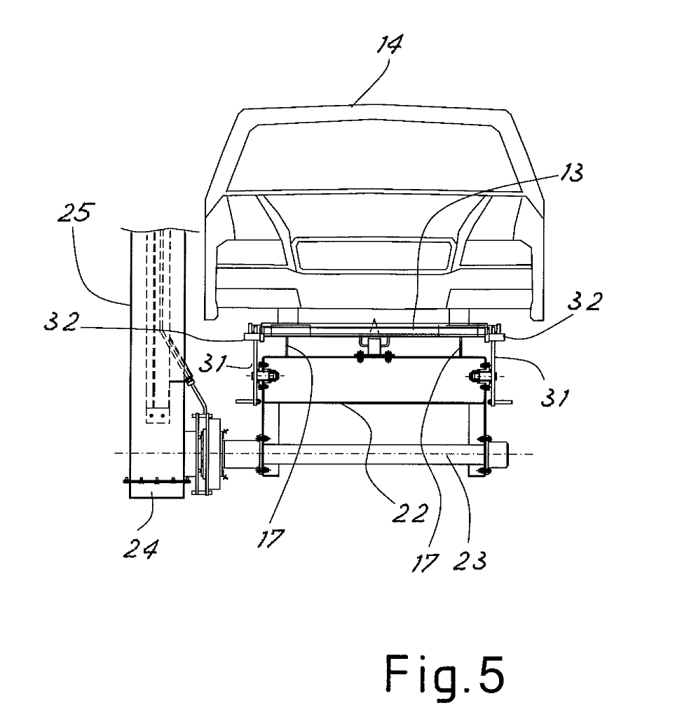

FIG. 5 shows an enlarged schematic front view of a part of a movement assembly of the plant;

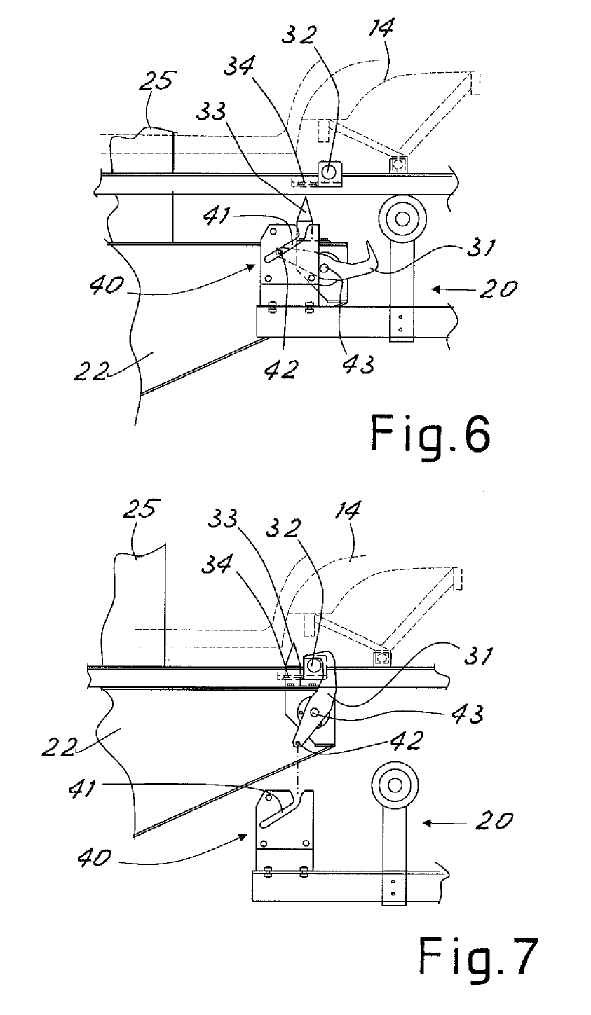

FIGS. 6 and 7 show partial schematic views of an engaging mechanism of the movement assembly during two operating steps;

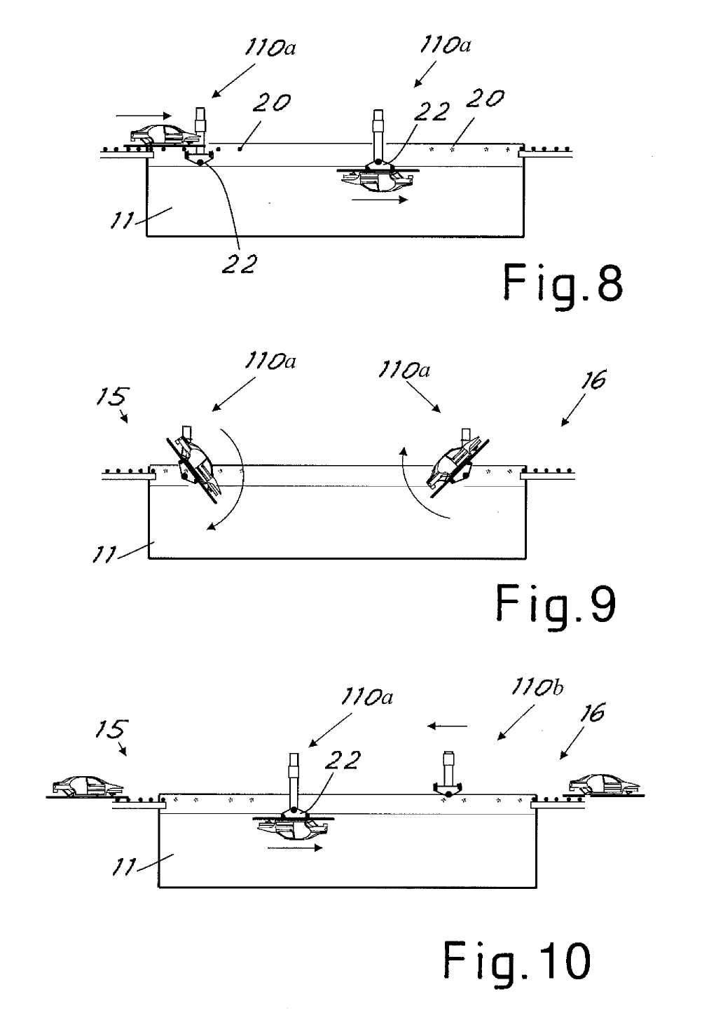

FIGS. 8 and 10 show schematic side elevation views of operating steps of the plant according to the invention.

With reference to the figures, FIG. 1 shows a plant, generally denoted by 10, for the dipping treatment of bodies, in particular bodies of motor vehicles or the like. In the present description reference will be made to a car body, but it is understood that the innovative principles of the present invention may also be applied to different bodyworks, for example lorry bodies.

The plant 10 comprises at least one suitably sized basin 11 filled with a known processing liquid suitable for the particular application carried out on the bodywork, for example a cataphoresis or anti-corrosive pre-treatment or treatment.

A sequential conveying line 12 conveys inside and outside of the plant a plurality of skids 13 each with an associated bodywork 14 arranged on top. In particular the line will convey a skid with a bodywork to be treated in the plant from an entry end 15 of the basin and will remove the skid with the bodywork following treatment from an opposite exit end 16.

Each skid is intended to support a bodywork to be treated and shall be provided with known systems for fixing the bodywork onto it, these not being further described or shown here since they can be easily imagined by the person skilled in the art.

As can be clearly seen also in the other figures, the skids comprise a pair of parallel bottom runners 17 intended to travel along roller units.

The conveying line 12 comprises corresponding roller units 18, 19 which lead to the entry point 15 and depart from the exit end 16 of the plant.

In the region of the basin the plant comprises two immersion and conveying assemblies 110a and 110b.

The plant also comprises at the two ends of the basin two roller units 20 and 120 for slidably displacing the skid, which are movable, as will be explained below, between an operating position where they support and slidably move the skid above the basin 11 and a non-operating retracted position where the skid with the bodywork can pass vertically for immersion inside and emersion from the underlying basin 11.

Each conveying and immersion assembly comprises a system 21 for vertically moving a skid which has been conveyed above the basin by means of the conveying line 12. The movement system 21 performs raising of the skid together with the bodywork from the rollers of the roller unit and subsequent repositioning thereon.

Each conveying and immersion assembly also comprises a horizontal movement system 150 which moves the vertical displacement system along the basin. Each horizontal system 150 is advantageously formed by means of a suitable motor-driven carriage 151 (for example a motor unit) which travels along corresponding rails 151 extending along a respective side of the basin between the entry and exit zones at the two ends of the basin.

As can be clearly seen in FIG. 1, the two conveying and immersion assemblies are arranged on opposite sides of the basin so as to allow their alternating movement along the basin, as will be clarified below.

For the sake of simplicity, reference will be made below to only one of the two assemblies 110a, 110b, the other assembly being substantially identical, except for the fact that its structure has a mirror arrangement relative to the longitudinal extension of the basin. Similarly, since the roller units 20 and 120 are substantially identical to each other, below reference will be made to only one of them, also as regards the interaction with the immersion and conveying assemblies.

As can be clearly seen in FIGS. 2, 3 and 4, each vertical movement system 21 comprises a platform 22 for supporting and engaging with the skid, which is supported on a single motor-driven rotational shaft 23 which is horizontal and transverse to the extension of the skid (and therefore in general to the direction of movement of the skid between the entrance and exit).

The rotational shaft is preferably arranged in the middle between the front end and rear end of the platform and, advantageously, is offset with respect to the exact centre line of the platform in order to facilitate rotation in one direction.

The shaft 23 is in turn supported so as to project close to the bottom end 24 of at least one vertical support aim 25 which is driven so as to travel vertically for the vertical movement of the platform. Advantageously, for the travel movement the vertical arm has its top end supported by a carriage 26 which is driven so as to travel vertically along a suitable vertical guide. Advantageously a motor 27 performs, via a chain or toothed-belt drive 28, the vertical movement of the carriage 26, while a motor 29 performs, via a chain or toothed-belt drive 30, the rotation of the platform. Advantageously, the motor 29 is arranged at the top end of the arm 25 which is not immersed inside the basin and the chain drive is sealed.

Alternatively, the vertical movement may be performed by means of an electric cylinder.

In this way damaging contact between the treatment liquid and the platform drive system is avoided.

The platform may thus be operated so as to rotate about the shaft 23 in order to incline the bodywork.

Advantageously, the platform may be operated so as to rotate about the said motor-driven transverse axis until the bodywork on the skid is rotated upside down. As can be seen in broken lines in FIG. 2, this rotation may be advantageously at least through 180° so as to achieve also the complete overturning of the bodywork, when desired or required for the quality of the treatment.

Again advantageously, the carriage 26 travels along a vertical pillar 35 which is arranged alongside the basin and with its bottom end supported by the motor unit carriage 151 of the horizontal displacement system 150.

In order to allow inclination or overturning of the bodywork, the platform 22 comprises means for engaging with the skid so as to avoid inappropriate movements and falling of the skid onto the platform.

In the preferred embodiment described here, in order to provide these engaging means, the platform comprises hooks 31 which are movable between an operating position for stable engagement of the skid on the platform and a non-operating position where it is disengaged. For engagement of the skid, the latter may be advantageously provided with laterally projecting pins 32 with which the hooking elements are coupled.

Means for moving the hooks between an operating position and non-operating position are also present in the station so as to perform the movement of the engaging means at the appropriate time and engage the skid with the platform before immersion with rotation as well as disengage the skid at the end of treatment.

Advantageously, the engaging means may be operated, as will be clarified below, by the movement of the roller units 20 between the operating position and the non-operating position and/or by the skid raising system.

Centring pins 33 projecting vertically from the platform may also be advantageously provided so as to engage inside corresponding centring seats 34 in the skid and ensure correct relative positioning, avoid movements parallel to the surface of the platform and not exert an excess shearing stress on the hooks.

The hooks are thus required to perform only the separating movement of the platform and skid in a direction perpendicular to the platform (namely parallel to the axis of the centring pin) and are therefore simplified.

As can be clearly seen in FIG. 4, the hooks are advantageously four in number and arranged in pairs close to the corners and on the two sides of the platform. The skid will have correspondingly four laterally projecting engaging pins 32.

As can be clearly seen in FIGS. 3 and 4, the two roller units 20 and 120, arranged close to the ends of the basin, are advantageously formed so as to each comprise a side unit 20b on each side of the travelway of the conveying system (namely on each side of the longitudinal direction of travel for entry/exit of the bodywork). Again advantageously, each side unit 20a and 20b is formed respectively by motor-driven travel rollers 30 which are mounted projecting towards the longitudinal centre line of the basin and which face corresponding rollers of the side unit on the other side of the travelway.

The rotation of the rollers of the units 20, 120 is advantageously performed by respective motors 44, via suitable toothed belts 45.

As can be clearly seen again in FIGS. 3 and 4, the roller units are movable so as to displace the rollers 38 from an advanced operating position (shown in broken lines in the figures) into a retracted non-operating position (shown in solid lines in the figures). In the operating position, the rollers advantageously project from the side walls of the basin towards the centre line of the basin and in this position the runners of the skid may rest on the rollers and the skid may be displaced by suitable known displacement means along the travelway. In the non-operating position, the rollers are at least partially retracted inside the side walls of the basin and free the vertical space above the basin so as to allow the skid and the bodywork to pass through for the immersion or emersion movement without encountering obstacles. Advantageously, the displacement of the roller units between the operating position and non-operating position is perforated by means of respective motors 46 and suitable rack drives 47.

Obviously, before retraction of the roller units into the non-operating position, the skid must be taken up by the platform 22 of the one of the conveying and immersion assemblies 110a.

As can be seen in particular in FIGS. 2, 3 and 4 and, on a larger scale, in FIGS. 6 and 7, advantageously each roller unit comprises actuating cams 40 for actuating the locking hooks 31. Advantageously the cams are in the form of plates with a cam slit 41 inside which an actuating pin 42 laterally projecting from an operating end of the hook, rotatably supported about an axis 43 parallel to the axis of the platform, can be suitably inserted and displaced.

As can be clearly seen from a comparison of FIGS. 6 and 7, operation is thus performed so as to cause automatic engagement of the skid when the platform raises the skid from the rollers 38 and automatic disengagement of the skid when the platform repositions the skid on the rollers 38.

The two conveying and immersion assemblies 110a, 110b may thus alternately remove a skid with the bodywork from the front end of the basin, raising it from the roller unit 20, lower it again when the rollers are retracted and immerse it in the basin in a predefined manner, convey it immersed towards the rear end of the basin, raise it again outside of the basin and rest it on the roller unit 120 so that it may be conveyed away on the roller unit 19.

In particular, during use at the start of a treatment cycle for a bodywork one of the two assemblies 110a, 110b is brought into the position at the front of the basin, in the region of the roller units 20 and the rollers are advanced into the operating position. The hooks of the platform will be open.

In this condition, the platform (situated immediately below the travel plane of the conveying line, as can be seen in FIG. 6) does not hinder displacement on the rollers of the incoming skid.

When the skid is in position on the platform, the platform may be raised (since it has dimensions which allow to travel vertically without interfering with the rollers in the operating position, as can be clearly seen for example in FIG. 4). The centring pins 32, if present, engage inside the seats 34 on the skid and the skid is raised by the platform. When the skid is suitably raised, the actuating pins 42 are completely disengaged from the cam slits 41 and the skid locked and is completely supported by the platform, as can be clearly seen in FIG. 7.

Thereafter, the roller units are able to be retracted in their non-operating positions shown in solid lines in FIGS. 3 and 4.

The platform may thus move downwards again and rotate so as to immerse the bodywork in the liquid of the basin, where necessary with rotation of the platform so as to allow programmed inclination movements (for example so as to immerse the body, inclined at its front end, in successive stages) until it is completely overturned (as shown in broken lines in FIG. 2). Also combinations of different movements may be performed in order to achieve more rapid evacuation of the air from the body and uniform coating with the process liquid. The plant may also be suitably programmed so as to perform easily different optimum movements depending on the bodywork to be processed.

Advantageously, the axis of rotation of the platform may be kept outside the basin (as can be clearly seen in FIG. 2) during the pivoting and/or rotational movements. The hydraulic seal around the shaft is thus subject to less stress.

During the immersion step the displacement system 150 conveys the bodywork along the basin as far as the opposite end, where the roller unit 120 is present.

During displacement the platform may also perform programmed pivoting movements about the horizontal plane.

At the end of the dipping treatment step, the platform, upon reaching the rear end of the basin, may rotate (once again with all the rotational and/or inclined movements considered suitable for the body being processed) until it is arranged again horizontally in the emersed position above the roller unit 120.

The roller unit 120 may then be brought into its advanced operating position and the platform may be lowered again into the deposition position with simultaneous engagement of the pins 42 of the hooks inside the respective cams and the consequent disengagement of the skid from the platform and its rearrangement on the conveying rollers. Operation of the motors for rotation of the rollers pushes the skid with the bodywork towards the exit 16. The conveying and immersion system may this move rapidly backwards so as to return into the starting position at the front of the basin, so as to be ready for the next skid with a new bodywork to be processed.

The other conveying and immersion unit performs the same movements described here, but in counter-synchronism with the first conveying unit so that, while one unit performs the immersion of a bodywork and conveys it inside the basin as far as the exit end, the other unit performs the conveying and emersion of a preceding bodywork and resurfacing towards the entry point of the bodyworks, passing above the platform which is immersed.

In this way, the time required for immersion of a bodywork is optimized and also long basins may be used with advantageous results.

FIGS. 8 to 10 show in schematic form a possible treatment sequence. For example, FIG. 8 shows a step for transferring, while immersed, an overturned bodywork, with simultaneous loading of the next body at the entry end of the basin.

FIG. 9 shows the following step of immersion of the bodywork at the entry end of the basin, while simultaneously the step for emersion of the bodywork which has reached the exit end of the basin is performed. Rotation may occur in either direction so as to optimize evacuation of the air and the subsequent outflow of the liquid, also depending on the type and form of the bodywork.

The return of the conveying and immersion unit may be much faster than the forwards movement with the bodywork immersed. In this way, as shown for example in FIG. 10, the loaded unit may convey immersed the bodywork, while the other unit rapidly returns to the start of the basin, in order to resume the condition shown in FIG. 8. The unit, once it has returned to the starting position, may thus load and then immerse the next bodywork while the other unit is still performing the travel movement with immersion. The operations may thus be performed in parallel and this allows the efficiency of the plant to be increased significantly.

At this point it is clear how the predefined objects have been achieved. For example, a high degree of flexibility may be achieved with a plant constructed in accordance with the principles of the present invention, it being possible to perform movements of the bodywork during immersion, emersion and positioning in the liquid, whereby these movements have been found to be optimum for optimizing the speed, quality of treatment and stress acting on the bodywork. Moreover, the plant is relatively simple and has a limited volume in relation to the efficiency and the duration of immersion. The system is moreover “enclosed” in the treatment basin and only the skids (which have a simple and robust structure) pass from one basin to the remainder of the plant (usually comprising other basins). Contamination of the basins arranged in succession is thus also avoided. It is thus also simple to expand the plant in accordance with varying treatment or productivity requirements.

Obviously, the above description of an embodiment applying the innovative principles of the present invention is provided by way of example of these innovative principles and must therefore not be regarded as limiting the scope of the rights claimed herein. For example, other basins may be arranged in sequence, each with its own conveying and immersion system comprising a double or single conveying and immersion unit, depending on the treatment to be performed and the length of the basin. Moreover other systems may be provided for locking the skid on the platform, for example in the form of motorized actuators for locking hooks.

Finally, “skid” is understood as referring to a generic component which allows the movement and engagement of a bodywork and may be different from that shown, it also being possible for it to be at least partially dispensed with or form part of the bodywork itself.

1. A plant for dipping treatment of bodyworks, the plant comprising:
at least one processing liquid basin;
a conveying line for sequential arrival of skids toward a front end of the basin and sequential departure of the skids from a rear end of the basin, wherein the skids are each configured to support a bodywork to be treated;
a first roller unit and a second roller unit above the basin, wherein the first roller unit is at the front end of the basin in order to release the skids toward the conveying line, and the second roller unit is at the rear end of the basin in order to receive the skids from the conveying line, wherein the rollers of the first and second roller units are configured to move between a first non-operating position and a first operating position for slidably displacing and supporting the skids above the basin at a corresponding end of the basin; and
two immersion and conveying assemblies, each provided with a movable platform for supporting and engaging the skids, for removing a respective one of the skids from the first roller unit, conveying the respective one of the skids immersed along the basin, and depositing the respective one of the skids onto the second roller unit;
wherein the platform is supported with a transverse, motor-driven, rotating shaft that projects from a support arm,
wherein the support arm is motor-driven for vertical movement of the platform, and
wherein the platform is moved by a motor-driven system for alternating displacement of the platforms of the two immersion and conveying assemblies along the basin between the first and second roller units.

2. The plant of claim 1, wherein the two immersion and conveying assemblies are situated in a mirror arrangement on opposite side edges of the basin so as to project with a respective platform from the opposite side edges of the basin.

3. The plant of claim 1, wherein the support arm is supported on a motor-driven carriage that travels along a vertical guide pillar alongside the basin and is supported by the a respective motor-driven system for displacement along the basin.

4. The plant of claim 1, wherein each motor-driven system for displacement along the basin comprises a motor-driven carriage that travels along rails at a respective side edge of the basin.

5. The plant of claim 1, wherein the roller units comprise a side unit on each side edge of the basin, with rollers which are facing on the two sides of the basin and which project toward each other from the side edges of the basin when the rollers are in the first operating position and which are retracted into the side edges of the basin when the rollers are in the first non-operating position.

6. The plant of claim 1, wherein the platform may be operated so as to rotate about an axis of the rotating shaft until a respective bodywork on the respective one of the skids is upside down.

7. The plant of claim 1, wherein the platform comprises:
hooks that are movable between a second operating position, for stable engagement of the respective one of the skids on the platform, and a second non-operating position, where the respective one of the skids is disengaged, and
devices configured to move the hooks between the second operating position, for engaging the respective one of the skids with the platform, and the second non-operating position, for disengaging the respective one of the skids from the platform.

8. The plant of claim 4, wherein each of the roller units comprises cams for actuating hooks so as to cause:
automatic engagement of the respective one of the skids when the platform raises the respective one of the skids from the rollers of the roller unit; and
automatic disengagement of the respective one of the skids when the platform repositions the respective one of the skids on the rollers of the roller unit.

9. The plant of claim 1, wherein the rotating shaft is kinematically connected, via a drive chain or toothed belt, to a rotational motor close to a top end of the support arm.

10. A sequential movement method for the dipping treatment of a plurality of bodyworks in a plant, the plant comprising at least one processing liquid basin; a conveying line for sequential arrival of skids toward a front end of the basin and sequential departure of the skids from a rear end of the basin, wherein the skids are each configured to support a bodywork to be treated; a first roller unit and a second roller unit above the basin, wherein the first roller unit is at the front end of the basin in order to release the skids toward the conveying line, and the second roller unit is at the rear end of the basin in order to receive the skids from the conveying line, wherein the rollers of the first and second roller units are configured to move between a first non-operating position and a first operating position for slidably displacing and supporting the skids above the basin at a corresponding end of the basin; and two immersion and conveying assemblies each provided with a movable platform for supporting and engaging skids, for removing a respective one of the skids from the first roller unit, conveying the respective one of the skids immersed along the basin, and depositing the respective one of the skids onto the second roller unit, wherein the platform is supported by a transverse, motor-driven, rotating shaft that projects from a support arm, wherein the support arm is motor-driven for vertical movement of the platform, and wherein the platform is moved by a motor-driven system for alternating displacement of the platforms of the two immersion and conveying assemblies along the basin between the first and second roller units; the method comprising:
performing sequentially, using one of the two immersion and conveying assemblies, a movement for immersion and conveying, immersed between the first roller unit and the second roller unit a respective bodywork arriving on the first roller unit and returning the respective bodywork onto the second roller unit, while the other of the two immersion and conveying assemblies performs an opposite return movement above the basin between the second roller unit and the first roller unit for removal of a next bodywork arriving at the first roller unit.

11. The method of claim 10, wherein alternately while the one of the two immersion and conveying assemblies performs the immersion of a first bodywork at the front end of the basin and then continues toward the rear end the basin, the other of the two immersion and conveying assemblies performs the emersion of a second bodywork at the rear end of the basin and then returns empty to the front end of the basin, passing with a respective platform above the basin.

12. The plant of claim 1, wherein each of the roller units comprises cams for actuating hooks so as to cause:
automatic engagement of the respective one of the skids when the platform raises the respective one of the skids from the rollers of the roller unit; and
automatic disengagement of the respective one of the skids when the platform repositions the respective one of the skids on the rollers of the roller unit.

13. The plant of claim 1, wherein the first roller unit comprises cams for actuating hooks so as to cause:
automatic engagement of the respective one of the skids when the platform raises the respective one of the skids from the rollers of the first roller unit.

14. The plant of claim 1, wherein the second roller unit comprises cams for actuating hooks so as to cause:
automatic disengagement of the respective one of the skids when the platform repositions the respective one of the skids on the rollers of the second roller unit.
